(19) United States
(12) Patent Application Publication
(10) Pub. No.: US 2022/0327172 A1
(43) Pub. Date: Oct. 13, 2022

(54) Evaluation and Recommendation Engine for a Remote Network Management Platform

(71) Applicant: ServiceNow, Inc., Santa Clara, CA (US)

(72) Inventors: Lynn Medina Davies, Staines (GB); Christopher John Dowse, Carmel, CA (US); Michelle Graham, St. Louis, MO (US); Gregory Cunningham, Modesto, CA (US); Praveen Naga Vennam, San Ramon, CA (US)

(21) Appl. No.: 17/226,700

(22) Filed: Apr. 9, 2021

(51) Int. Cl. G06F 16/9535; G06F 16/22; G06F 16/28; G06F 16/2457

(52) U.S. Cl. CPC G06F 16/9535; G06F 16/2282; G06F 16/285; G06F 16/24578

(57) ABSTRACT

Persistent storage contains data generated by applications, parameters of a telemetry application, and a tree-like arrangement of calculations that estimates a present value. Processor(s) are configured to cause the telemetry application to: obtain a first set of data generated by a first application; obtain a second set of data generated by a second application, the first and second applications belonging to an application class; determine a first present value for the first application based on the arrangement, the first set of data, and the parameters; determine a second present value for the second application based on the arrangement, the second set of data, and the parameters; determine a class present value of the application class based on the arrangement, the first present value, and the second present value; and determine an overall present value based on the arrangement, the class present value, and present values of other application classes.

### BACKGROUND

More and more enterprise computing functionality is migrating to cloud-based systems. These systems provide computing resources (e.g., processing, networking, and storage), as well as operating systems, middleware, application frameworks, and/or applications useable by the enterprises in various ways. Thus, different systems may customize these components in different fashions based on the respective enterprises' needs. Given this complexity and flexibility, it has become important for enterprises to be able to evaluate the tangible value that they are receiving from use of these systems, and whether there are opportunities to leverage the systems for further value. But no such capabilities exist, particular ones that provide evaluations of enterprise usage in terms of one or more simple indices or metrics.

### SUMMARY

The embodiments herein overcome these and possibly other technical problems by providing mechanisms through which telemetry data can be collected from a computational instance of a cloud-based remote network management platform that is used by an enterprise. The data sources for the telemetry data might be one or more database tables, configuration files, log files, and/or user profiles, and may represent key performance indicators (KPIs) and/or metrics of the computational instance. The KPIs and/or metrics may be arranged in various ways (e.g., into feature vectors) and processed by statistical algorithms. These algorithms may involve measures of descriptive statistics, inferential statistics, deep learning (or other types of machine learning), principal component analysis, or some ensemble of these or related techniques. The output of these algorithms may include one or more indicators that measure the present value, potential value, and/or digital maturity of the enterprise's use of the computational instance. The indicator(s) can be used to track trends for a given computational instance, or compare computational instances of two or more enterprises. This, as well as potential alternative or additional output, may include metrics that can be used to generate graphs, heatmaps, dashboards, and/or other visual representations of the present value, potential value, and/or digital maturity.

Accordingly, a first example embodiment may involve persistent storage containing respective sets of data generated by each of a plurality of applications executable on a system, a set of parameters associated with operation of a telemetry application, and a tree-like arrangement of calculations that estimates a present value of the system based on the respective sets of data and the set of parameters, wherein the applications respectively belong to application classes. The first example embodiment may further involve one or more processors configured to cause the telemetry application to: obtain a first respective set of data generated by a first application of the plurality of applications; obtain a second respective set of data generated by a second application of the plurality of applications, wherein the first application and the second application both belong to a first application class; determine a first present value for the first application based on the tree-like arrangement, the first respective set of data, and the set of parameters; determine a second present value for the second application based on the tree-like arrangement, the second respective set of data, and the set of parameters; determine a first class-based present value of the first application class based on the tree-like arrangement, the first present value, and the second present value; and determine the present value of the system based on the tree-like arrangement, the first class-based present value, and one or more other class-based present values of other application classes.

A second example embodiment may involve obtaining, by a telemetry application, a first respective set of data generated by a first application of a plurality of applications executable on a system, wherein persistent storage contains respective sets of data generated by each of the plurality of applications, a set of parameters associated with operation of the telemetry application, and a tree-like arrangement of calculations that estimates a present value of the system based on the respective sets of data and the set of parameters, wherein the applications respectively belong to application classes. The second example embodiment may further involve obtaining, by the telemetry application, a second respective set of data generated by a second application of the plurality of applications, wherein the first application and the second application both belong to a first application class. The second example embodiment may further involve determining, by the telemetry application, a first present value for the first application based on the tree-like arrangement, the first respective set of data, and the set of parameters. The second example embodiment may further involve determining, by the telemetry application, a second present value for the second application based on the tree-like arrangement, the second respective set of data, and the set of parameters. The second example embodiment may further involve determining, by the telemetry application, a first class-based present value of the first application class based on the tree-like arrangement, the first present value, and the second present value. The second example embodiment may further involve determining, by the telemetry application, the present value of the system based on the tree-like arrangement, the first class-based present value, and one or more other class-based present values of other application classes.

In a third example embodiment, an article of manufacture may include a non-transitory computer-readable medium, having stored thereon program instructions that, upon execution by a computing system, cause the computing system to perform operations in accordance with the first and/or second example embodiment.

In a fourth example embodiment, a computing system may include at least one processor, as well as memory and program instructions. The program instructions may be stored in the memory, and upon execution by the at least one processor, cause the computing system to perform operations in accordance with the first and/or second example embodiment.

In a fifth example embodiment, a system may include various means for carrying out each of the operations of the first and/or second example embodiment.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5A depicts another communication environment involving a remote network management architecture, in accordance with example embodiments.

FIG. 5B is a flow chart, in accordance with example embodiments.

FIG. 6 is a logical grouping of computational instances, in accordance with example embodiments.

FIG. 7 depicts a process for determining values representing various aspects of a computational instance, in accordance with example embodiments.

FIG. 8 is a block diagram representing data sources, parameters, telemetry application algorithms, and metrics, in accordance with example embodiments.

FIG. 9 depicts a hub-spoke-feeder architecture, in accordance with example embodiments.

FIG. 10A depicts a hierarchy for calculating a present value for one or more computational instances, in accordance with example embodiments.

FIG. 10B depicts part of the hierarchy of FIG. 10A in more detail, in accordance with example embodiments.

FIG. 11A depicts quartiles of a present value distribution, in accordance with example embodiments.

FIG. 11B depicts a hierarchy for calculating a potential value for one or more computational instances, in accordance with example embodiments.

FIG. 12 depicts a hierarchy for calculating a digital maturity for one or more computational instances, in accordance with example embodiments.

FIG. 13 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Introduction

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM) and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) is introduced, to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure.

The aPaaS system may support standardized application components, such as a standardized set of widgets for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional MVC application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HTML and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### II. Example Computing Devices and Cloud-Based Computing Environments

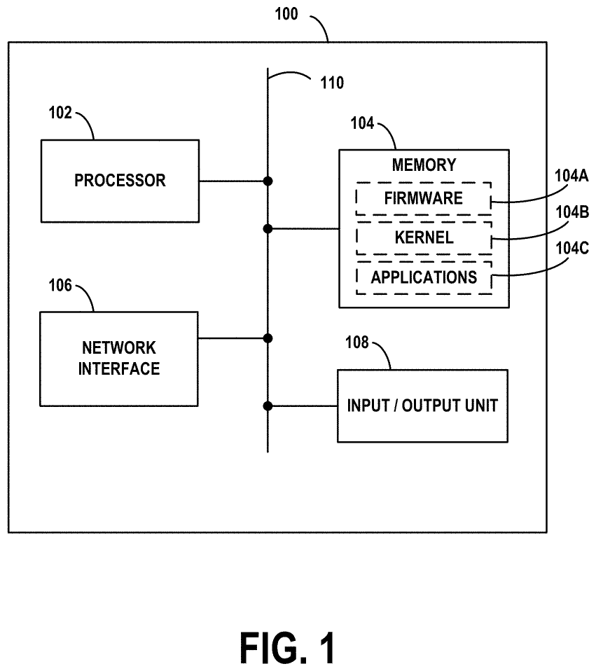

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a co-processor (e.g., a mathematics, graphics, or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage. Other types of memory may include biological memory.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, and so on). Network interface 106 may also support communication over one or more non-Ethernet media, such as coaxial cables or power lines, or over wide-area media, such as Synchronous Optical Networking (SONET) or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed to support an aPaaS architecture. The exact physical location, connectivity, and configuration of these computing devices may be unknown and/or unimportant to client devices. Accordingly, the computing devices may be referred to as “cloud-based” devices that may be housed at various remote data center locations.

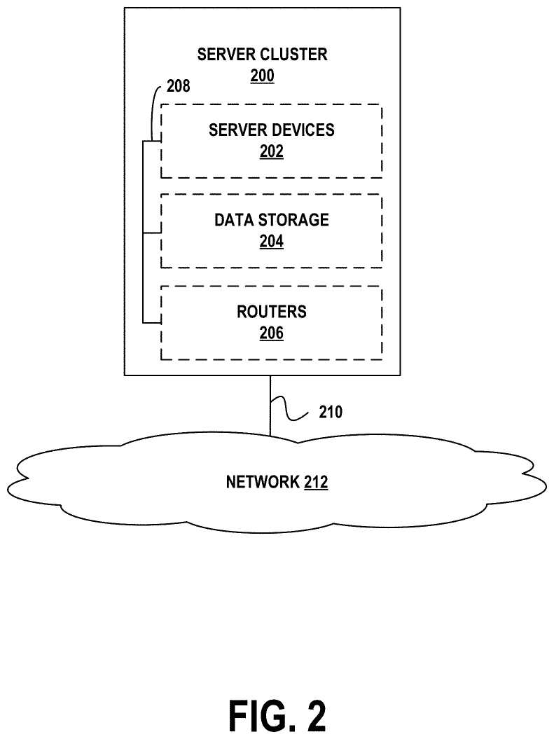

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database. Various types of data structures may store the information in such a database, including but not limited to tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as the hypertext markup language (HTML), the extensible markup language (XML), or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### III. Example Remote Network Management Architecture

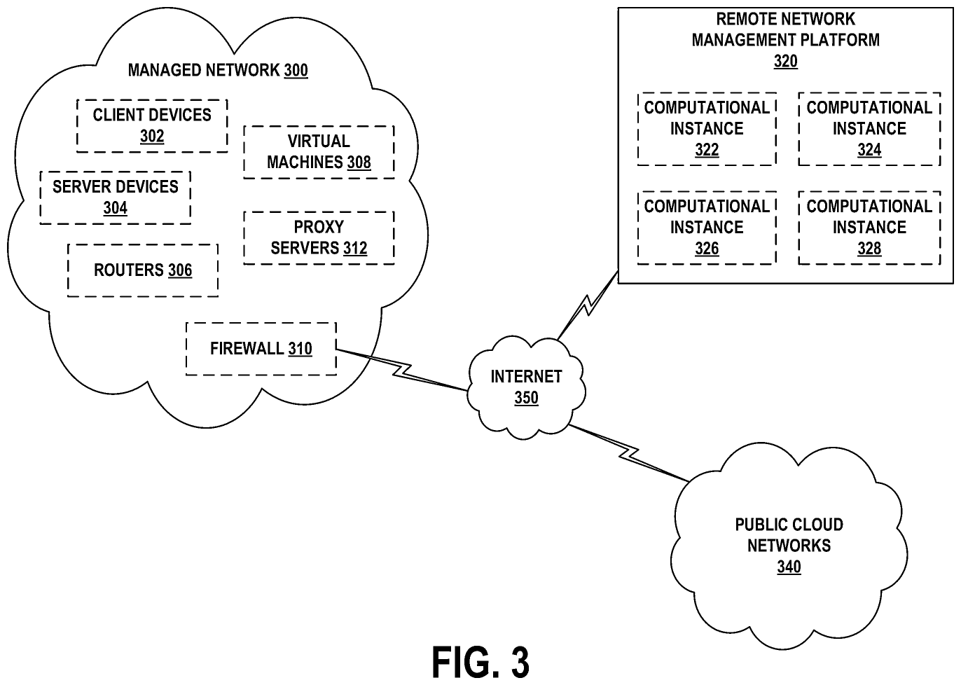

FIG. 3 depicts a remote network management architecture, in accordance with example embodiments. This architecture includes three main components-managed network 300, remote network management platform 320, and public cloud networks 340-all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components. Possibly with the assistance of proxy servers 312, remote network management platform 320 may also be able to discover and manage aspects of public cloud networks 340 that are used by managed network 300.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may impact all customers' data, creating additional risk, especially for entities subject to governmental, healthcare, and/or financial regulation. Furthermore, any database operations that impact one customer will likely impact all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include AMAZON WEB SERVICES® and MICROSOFT® AZURE®. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

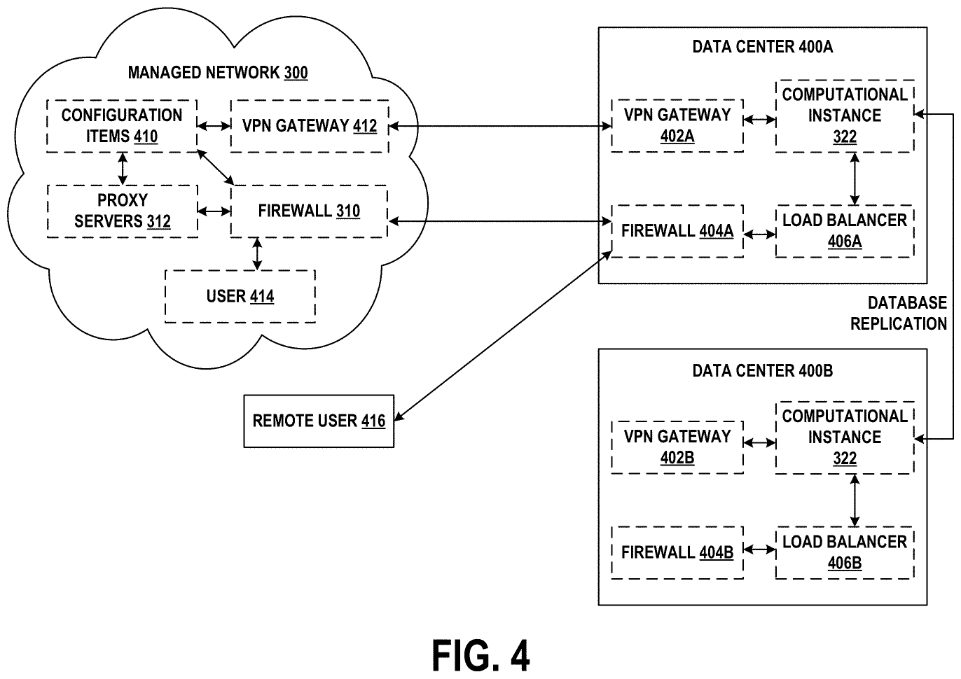

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any applications or services executing thereon, as well as relationships between devices, applications, and services. Thus, the term “configuration items” may be shorthand for any physical or virtual device, or any application or service remotely discoverable or managed by computational instance 322, or relationships between discovered devices, applications, and services. Configuration items may be represented in a configuration management database (CMDB) of computational instance 322.

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively).

### IV. Example Device, Application, and Service Discovery

In order for remote network management platform 320 to administer the devices, applications, and services of managed network 300, remote network management platform 320 may first determine what devices are present in managed network 300, the configurations and operational statuses of these devices, and the applications and services provided by the devices, as well as the relationships between discovered devices, applications, and services. As noted above, each device, application, service, and relationship may be referred to as a configuration item. The process of defining configuration items within managed network 300 is referred to as discovery, and may be facilitated at least in part by proxy servers 312.

For purposes of the embodiments herein, an “application” may refer to one or more processes, threads, programs, client modules, server modules, or any other software that executes on a device or group of devices. A “service” may refer to a high-level capability provided by multiple applications executing on one or more devices working in conjunction with one another. For example, a high-level web service may involve multiple web application server threads executing on one device and accessing information from a database application that executes on another device.

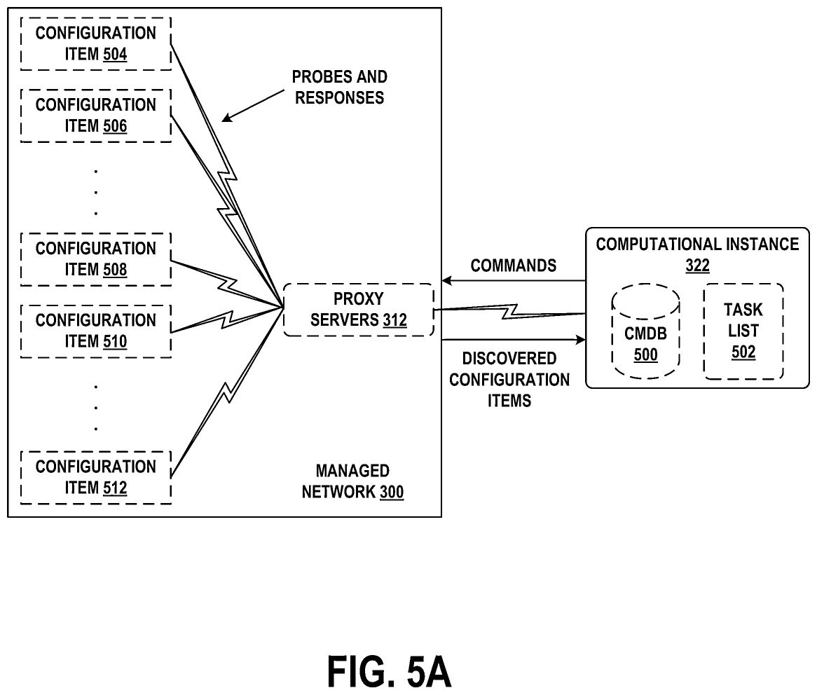

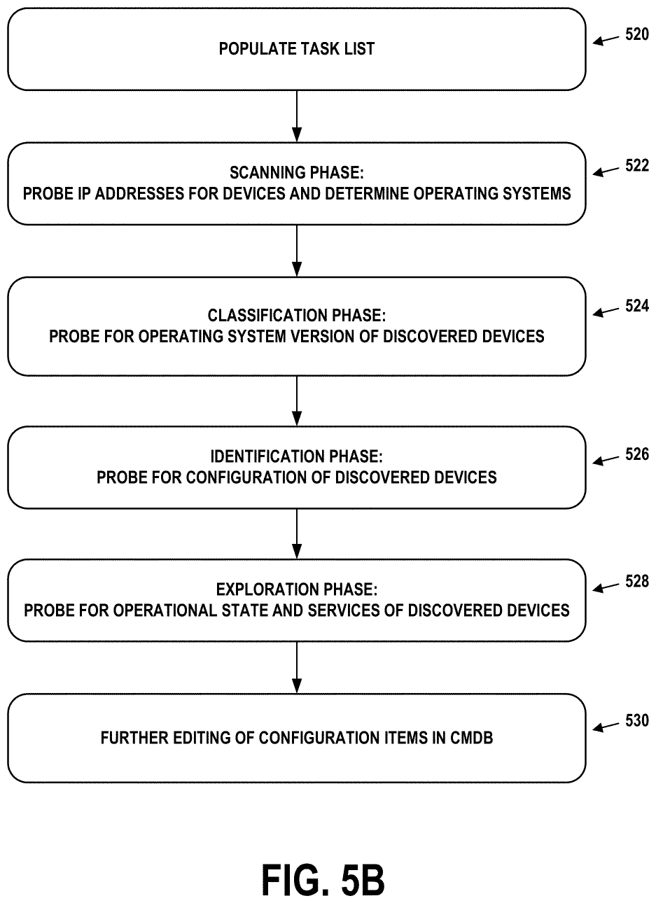

FIG. 5A provides a logical depiction of how configuration items can be discovered, as well as how information related to discovered configuration items can be stored. For sake of simplicity, remote network management platform 320, public cloud networks 340, and Internet 350 are not shown.

In FIG. 5A, CMDB 500 and task list 502 are stored within computational instance 322. Computational instance 322 may transmit discovery commands to proxy servers 312. In response, proxy servers 312 may transmit probes to various devices, applications, and services in managed network 300. These devices, applications, and services may transmit responses to proxy servers 312, and proxy servers 312 may then provide information regarding discovered configuration items to CMDB 500 for storage therein. Configuration items stored in CMDB 500 represent the environment of managed network 300.

Task list 502 represents a list of activities that proxy servers 312 are to perform on behalf of computational instance 322. As discovery takes place, task list 502 is populated. Proxy servers 312 repeatedly query task list 502, obtain the next task therein, and perform this task until task list 502 is empty or another stopping condition has been reached.

To facilitate discovery, proxy servers 312 may be configured with information regarding one or more subnets in managed network 300 that are reachable by way of proxy servers 312. For instance, proxy servers 312 may be given the IP address range 192.168.0/24 as a subnet. Then, computational instance 322 may store this information in CMDB 500 and place tasks in task list 502 for discovery of devices at each of these addresses.

FIG. 5A also depicts devices, applications, and services in managed network 300 as configuration items 504, 506, 508, 510, and 512. As noted above, these configuration items represent a set of physical and/or virtual devices (e.g., client devices, server devices, routers, or virtual machines), applications executing thereon (e.g., web servers, email servers, databases, or storage arrays), relationships therebetween, as well as services that involve multiple individual configuration items.

Placing the tasks in task list 502 may trigger or otherwise cause proxy servers 312 to begin discovery. Alternatively or additionally, discovery may be manually triggered or automatically triggered based on triggering events (e.g., discovery may automatically begin once per day at a particular time).

In general, discovery may proceed in four logical phases: scanning, classification, identification, and exploration. Each phase of discovery involves various types of probe messages being transmitted by proxy servers 312 to one or more devices in managed network 300. The responses to these probes may be received and processed by proxy servers 312, and representations thereof may be transmitted to CMDB 500. Thus, each phase can result in more configuration items being discovered and stored in CMDB 500.

In the scanning phase, proxy servers 312 may probe each IP address in the specified range of IP addresses for open Transmission Control Protocol (TCP) and/or User Datagram Protocol (UDP) ports to determine the general type of device. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist. Once the presence of a device at a particular IP address and its open ports have been discovered, these configuration items are saved in CMDB 500.

In the classification phase, proxy servers 312 may further probe each discovered device to determine the version of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 2012, as a set of WINDOWS®-2012-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (applications), and so on. Once more, the discovered information may be stored as one or more configuration items in CMDB 500.

Running discovery on a network device, such as a router, may utilize SNMP. Instead of or in addition to determining a list of running processes or other application-related information, discovery may determine additional subnets known to the router and the operational state of the router's network interfaces (e.g., active, inactive, queue length, number of packets dropped, etc.). The IP addresses of the additional subnets may be candidates for further discovery procedures. Thus, discovery may progress iteratively or recursively.

Once discovery completes, a snapshot representation of each discovered device, application, and service is available in CMDB 500. For example, after discovery, operating system version, hardware configuration, and network configuration details for client devices, server devices, and routers in managed network 300, as well as applications executing thereon, may be stored. This collected information may be presented to a user in various ways to allow the user to view the hardware composition and operational status of devices, as well as the characteristics of services that span multiple devices and applications.

Furthermore, CMDB 500 may include entries regarding dependencies and relationships between configuration items. More specifically, an application that is executing on a particular server device, as well as the services that rely on this application, may be represented as such in CMDB 500. For example, suppose that a database application is executing on a server device, and that this database application is used by a new employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular router fails.

In general, dependencies and relationships between configuration items may be displayed on a web-based interface and represented in a hierarchical fashion. Thus, adding, changing, or removing such dependencies and relationships may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

In order for discovery to take place in the manner described above, proxy servers 312, CMDB 500, and/or one or more credential stores may be configured with credentials for one or more of the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

The discovery process is depicted as a flow chart in FIG. 5B. At block 520, the task list in the computational instance is populated, for instance, with a range of IP addresses. At block 522, the scanning phase takes place. Thus, the proxy servers probe the IP addresses for devices using these IP addresses, and attempt to determine the operating systems that are executing on these devices. At block 524, the classification phase takes place. The proxy servers attempt to determine the operating system version of the discovered devices. At block 526, the identification phase takes place. The proxy servers attempt to determine the hardware and/or software configuration of the discovered devices. At block 528, the exploration phase takes place. The proxy servers attempt to determine the operational state and applications executing on the discovered devices. At block 530, further editing of the configuration items representing the discovered devices and applications may take place. This editing may be automated and/or manual in nature.

The blocks represented in FIG. 5B are examples. Discovery may be a highly configurable procedure that can have more or fewer phases, and the operations of each phase may vary. In some cases, one or more phases may be customized, or may otherwise deviate from the exemplary descriptions above.

In this manner, a remote network management platform may discover and inventory the hardware, software, and services deployed on and provided by the managed network. As noted above, this data may be stored in a CMDB of the associated computational instance as configuration items. For example, individual hardware components (e.g., computing devices, virtual servers, databases, routers, etc.) may be represented as hardware configuration items, while the applications installed and/or executing thereon may be represented as software configuration items.

The relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

The relationship between a service and one or more software configuration items may also take various forms. As an example, a web service may include a web server software configuration item and a database application software configuration item, each installed on different hardware configuration items. The web service may have a “depends on” relationship with both of these software configuration items, while the software configuration items have a “used by” reciprocal relationship with the web service. Services might not be able to be fully determined by discovery procedures, and instead may rely on service mapping (e.g., probing configuration files and/or carrying out network traffic analysis to determine service level relationships between configuration items) and possibly some extent of manual configuration.

Regardless of how relationship information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

### V. Evaluation and Recommendation Engine

As noted, an enterprise may simultaneously use multiple computational instances for various purposes, and each of these instances may provide dozens or hundreds of software applications that are used by hundreds or thousands of individuals. Given this complexity, it is becoming important for enterprises to be able to measure the usage of their computational instances at a granular level, and use these measurements as a basis for determining the present value that they derive from services provided by the instances. Further, since enterprises typically do not fully use each and every software application offered by the remote network management platform, it is also important to be able to also identify opportunities to increase these enterprises' use of the platform (and the corresponding value derived) where appropriate.

The embodiments herein provide these and other benefits by way of an evaluation and recommendation engine, which may include or be based on a telemetry application. This engine is software that either executes on a computational instance being analyzed or on an adjunct computing device with access to data from the computational instance. The engine scans the enterprise's instance or instances to gather sets of key performance indicators (KPIs) and/or metrics. From these, the engine develops indicators for present value (e.g., the value that the enterprise currently obtains from the platform), potential value (e.g., potential additional value that the enterprise could obtain from the platform), digital maturity (e.g., process execution speed, availability and quality of relevant data for these processes, level of personalization and customization of these processes), and so on. These indicators can then be used to alter or modify enterprise use of the platform in order to improve efficiency.

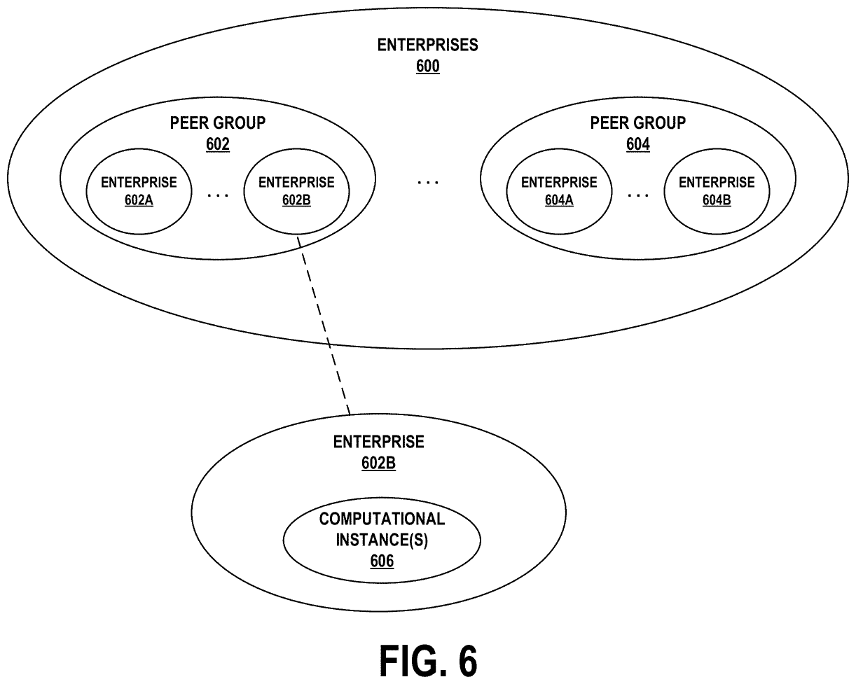

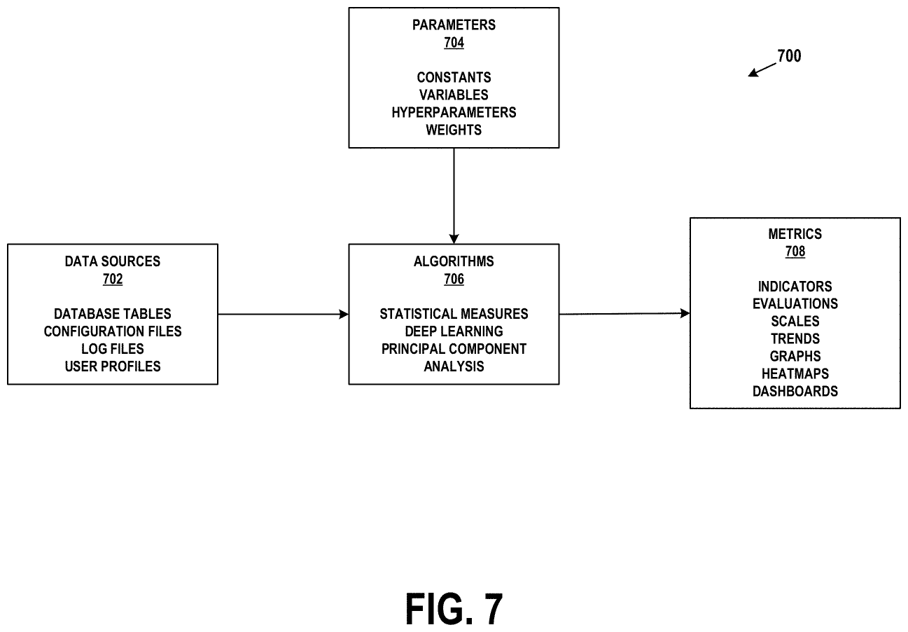

FIGS. 6 and 7 provide a high level overview of the environment in which the engine operates, as well as its inputs and outputs. Nonetheless, the overview provided by these figures is for purposes of example, and other representations may be possible.

FIG. 6 depicts enterprises 600 in an organizational sense, arranging these enterprises into peer groups. Here, peer groups represent various broad industries, such as IT, automotive, management consulting, manufacturing, engineering, and so on. For example, peer group 602 contains enterprises 602A and 602B, while peer group 604 contains enterprises 604A and 604B. Peer groups may be arranged so that each contains enterprises of approximately the same size in terms of revenue and/or employees. Thus, each industry might have multiple peer groups, e.g., one each for small, mid-sized, and large enterprises. Nonetheless, other arrangements of peer groups, including custom arrangements, may be possible. When these custom arrangements include too few peers in a group to provide insight into operations of these peers, the peers within the group may be augmented with additional entities in order to facilitate statistical significance.

The ellipses between peer groups 602 and 604, enterprises 602A and 602B, and enterprises 604A and 604B indicate that there may be more peer groups in enterprises 600, as well as more enterprises in peer group 602 and peer group 604. Enterprise 602B is also shown in a detailed view as making use of one or more computational instances 606. In this fashion, enterprise 602B is representative of the other enterprises, in that they each make use of respective computational instances.

Thus, each enterprise is associated with one or more computational instances and may also be part of a peer group. Therefore, it is advantageous to be able to determine the indicators for present value, potential value, and/or digital maturity for these computational instances. Doing so facilitates determining trends for these indicators as well as the ability to compare the indicators of different enterprises with one another whether or not these enterprises are in the same peer group.

FIG. 7 involves such a process at a high level and from the point of view of a single computational instance. Notably, a telemetry application may execute on the computational instance to collect data from data sources 702 and values of parameters 704, apply telemetry application algorithms 706 to the collected data and parameters, and provide metrics 708 based on the output of algorithms 706.

Data sources 702 may include database tables, configuration files, log files, and user profiles, for example. Other types of information within data sources 702 may be unstructured information, raw application output, and so on. The various software applications that execute on the computational instance may store data in certain database tables, read configuration information from certain configuration files, output data into certain log files, and/or base their operations on certain user profiles. Thus, collecting from data sources 702 helps determine how these software applications are configured to operate as well as aspects of their operation.

Parameters 704 may be constants, variables, hyperparameters, weights, and/or other values that control the operation of the telemetry application. These parameters may include constants, set by an administrator or user of a computational instance, which would otherwise be difficult or impossible to calculate. This means that the parameters may include estimates and/or approximations. Parameters 704 may be stored in a database table or configuration file, and read by the telemetry application upon initialization or as needed. Further, these parameters can be adjusted and saved on a per account basis to reflect the operations of any specific entity more accurately. The adjustment of these parameters without saving allows for various what/if simulation scenarios.

Telemetry application algorithms 706 may include statistical measures (e.g., descriptive statistics, inferential statistics), deep learning (or other types of machine learning), principal component analysis, or some ensemble of these or related techniques. Telemetry application algorithms 706 may apply these statistical measures to data sources 702 in accordance with parameters 704.

Metrics 708 represents the output of telemetry application algorithms 706. These may include the aforementioned indicators, as well as other evaluations, scales, trends, graphs, heatmaps, and/or dashboards generated based on the indicators. For example, an enterprise may use the telemetry application once per week to generate an indicator of the present value of its computational instance use. These indicators can be compared to one another to determine a trend over time (e.g., upwards, downwards, or static). Such a trend can be visualized in a graph or dashboard, for example. Further, the indicators can also be used to compare the enterprise's present value, potential value, and/or digital maturity to that of other enterprises in the same or other peer groups. In this fashion, the enterprise may be able to determine whether it is above, below, or at the average or median of these other enterprises with respect to present value, potential value, and/or digital maturity.

For enterprises that use more than one computational instance, the corresponding indicators for each may be combined in some fashion (e.g., by averaging, a weighted average, a median, etc.) to determine an overall indicator for the enterprise. In these cases, more weight may be given to computational instances that are in actual production use than to computational instances that are used primarily for testing or staging purposes. Further, weight may be assigned to computational instances based on the number of user accounts thereon, number of active users (e.g., users who have logged on at least once in the last week or month), actual use (e.g., CPU usage, main memory usage, disk usage), etc.

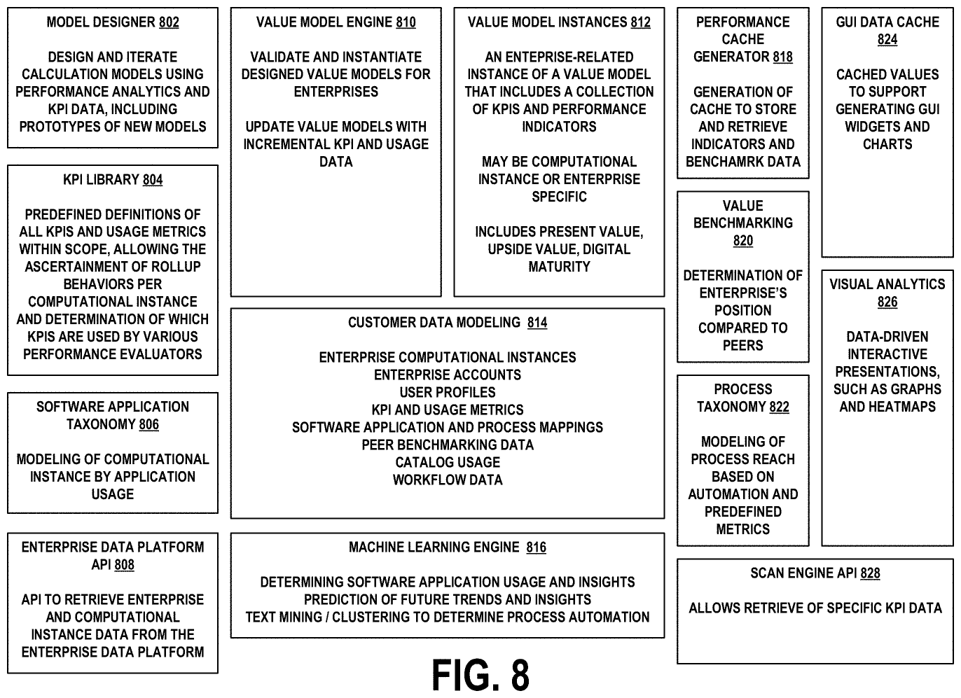

FIG. 8 provides a more detailed block diagram representing data sources 702 parameters 704, telemetry application algorithms 706, and metrics 708. The blocks of FIG. 8 might not map directly to any one of data sources 702 parameters 704, telemetry application algorithms 706, and metrics 708, and their functionality may instead be distributed across one or more of data sources 702 parameters 704, telemetry application algorithms 706, and metrics 708. For example, value model engine 810 might include aspects that could be logically categorized under parameters 704 and telemetry application algorithms 706. Further, some of the blocks of FIG. 8 may already exist as part of a current set of applications that operate on a computational instance (as opposed to the telemetry application), and the embodiments herein leverage the existence of these blocks.

Model designer 802 is a set of user interfaces and calculation models that allow the user to identify KPIs and/or metrics that ultimately can be used as input for calculation of one or more of metrics 708. These KPIs and/or metrics may be stored in KPI library 804. Examples of KPIs and/or metrics may include those related to application usage, application performance, process usage, process performance, how users employ applications, and so on. Specifically, in IT service management applications, for instance, KPIs and/or metrics might measure the number of incidents per time period (e.g., day, week, month), number of incidents caused by changes, mean time to resolution (MTTR) for incidents, and so on. In an HR application, however, KPIs and/or metrics might measure the time to fully onboard a new hire, the time to comply with a legal requirement, an annual attrition rate, as just a few examples. In a customer service management application KPIs and/or metrics might represent the average case-handling time, customer-reported satisfaction, and a rate of self-service adoption (e.g., through knowledgebase articles and virtual agent chat).

In some cases, enterprises may utilize or develop their own dashboard based on these KPIs and/or metrics. A dashboard could be generated by a performance analytics application, for instance, and may identify a set of KPIs and/or metrics, baseline values for each, goals for each, and a reporting frequency for each. Dashboards may also be used to define thresholds that, when crossed by a trigger actions (e.g., notifications, state changes, etc.). Dashboard logic may be incorporated into model designer 802.

Software application taxonomy 806 may be a categorization of applications used by and/or available to an enterprise by way of its computational instance(s). This allows modeling of each computational instance by application usage. For example, an enterprise might make heavy daily use of its IT service management application, but relatively little use of its HR or customer service management applications. Thus, the enterprise's use of its computational instance(s) may exhibit a high present value for the IT service management application but a low present value its use of the HR and customer service management applications, as well as a medium overall present value across all applications. On the other hand, the enterprise may exhibit a high potential value for potential use of the HR and customer service management applications.

Per-application usage data can be extracted from a computational instance by way of enterprise data platform API 808. This API may allow the telemetry application to request this usage data per application. For a given period of time (e.g., an hour, day, week, or month) and application, the usage data may include a number of users that accessed the application, an average session length of these users, an amount of data generated by the application (e.g., written to database tables or log files), and/or a number of transactions served. Examples of transactions may include incidents opened and incidents resolved in the IT service management applications, employees on-boarded in the HR application, as well as cases opened and cases resolved in the customer service management application.

Value model engine 810 may include functionality to validate models from model designer 802 and then instantiate these models. Once instantiated, these models may collect data and update their calculations.

Value model instances 812 represent the instantiated models. These may be separate models per computational instance, or one model that aggregates calculations across multiple computational instances. Also, there may be separate models for present value, potential value, and digital maturity, or a single model may incorporate calculations for two or more of these metrics.

Value model engine 810 may also cooperate with customer data modeling 814 to model enterprises and their computational instances. Customer data modeling 814 may be able to provide data collected regarding computational instances, enterprise accounts, user profiles, KPI and usage metrics, application and process mappings, peer benchmarking data (e.g., from the enterprise's peer group), catalog usage, and workflow data.

Machine learning engine 816 may use artificial intelligence to derive insights regarding application usage and trends that might not be practical to obtain in other manners. For example, determination of a trend involving millions of data elements collected over several months might be best performed by one or more machine learning algorithms. Such algorithms might involve classification, prediction, clustering, and/or other techniques based on text mining, natural language processing, and/or statistical techniques for example.

Value benchmarking 820 facilitates comparisons with metrics from value model instances 812 and those corresponding to other enterprises. This benchmarking could be a comparison to one enterprise, multiple enterprises, all peers, a market segment, and so on.

Process taxonomy 822 may involve modeling of process reach based on automation and other predefined metrics. This may include, for example, American Productivity and Quality Center (APQC) classifications of processes. These classifications allow enterprises to objectively track and compare their performance internally and externally with other enterprises from any industry.

Scan engine API 828 may allow the telemetry application to access further information, such as specific KPIs. In some embodiments, enterprise data platform API 808 may be combined with scan engine API 828.

Additionally, performance cache generator 818, GUI data cache 824, and visual analytics 826 make up a presentation layer that allows the user to visualize metrics and the results of the processing described herein. For example, the metrics may be presented on various types of dashboards that allow the user to drill down through its layers. To that point, performance cache generator 818 creates one or more caches to store indicators and benchmark data. One of these caches may be GUI data cache 824, which includes cached values that facilitate the rapid generation of GUI widgets and charts. These cached values may be representations of KPIs, metrics, raw data, and/or GUI elements. Visual analytics 826 may include logic that produces dashboards, and elements thereon, such as graphs, charts, tables, heatmaps, and so on.

FIG. 8 is presented for purposes of example. More or fewer blocks may be present in some implementations. Additionally, some blocks may have different functionality. Regardless, these blocks provide an operational framework for calculating present value, potential value, and digital maturity for one or more computational instances.

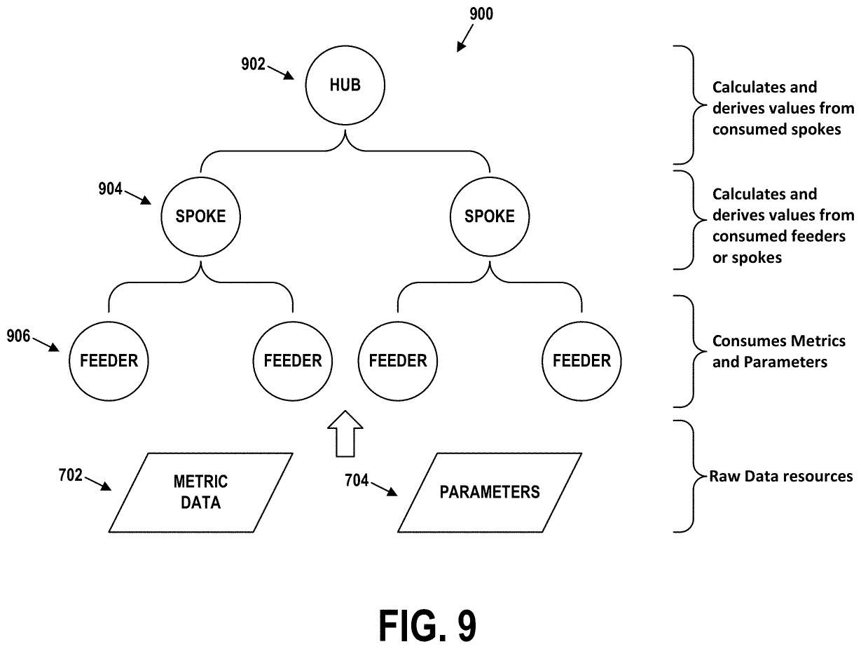

To that point, the calculations for each of these metrics may be based on a hub-spoke-feeder architecture. FIG. 9 depicts an example tree-like hierarchy 900 of a hub, spokes, feeder metrics, and raw data upon which the calculations are based.

Hub 902 provides a particular value at the highest level, and aggregates values from one or more spokes. For purposes of these embodiments, values represented at hub 902 may be present value, potential value, or digital maturity.

Spokes 904 are calculation layers that address a particular component of the overall value, and aggregate the values of one or more feeders. Spokes can consume the values of other spokes and therefore complex calculation layers of interdependent spokes can be used.

Feeder metrics 906 are the lowest level where data source 702 (otherwise referred to as raw data or metric data) and parameters 704 are provided to the model. Feeder metrics 906 can reference and transform any available data on or related to the computational instance.

Tree-like hierarchy 900 also supports the sharing of spokes 904 and/or feeder metrics 906 with hubs other than hub 902. For example, a spoke that determines level of workflow automation used by a hub for determining present value could also be used by a separate hub for determining the level of digital maturity.

Notably, the data representing present value, potential value, digital maturity, and various combinations thereof may be visually displayed in a number of ways using graphs, charts, tables, heatmaps, and so on. These displays may depict the current values of the data and/or trends indicating how the data has changed over time.

Furthermore, present value, potential value, and digital maturity may be calculated independently or somewhat independently. As explained below, potential value may depend on present value calculations, but digital maturity calculations may be independent of both present value and potential value.

### VI. Modeling Present Value

Present value is a calculation hub that is made up of a number of application class spokes. Each application class spoke has application spokes that define calculations based on a specific set of feeder metrics and parameters. For example, the application class spokes that feed into the hub provides values (e.g. in dollars, other currency, or in accordance with some other metric) that the related applications provide to users of the computational instance. Such application class spokes can be combined in some manner by the telemetry application to determine the present value.

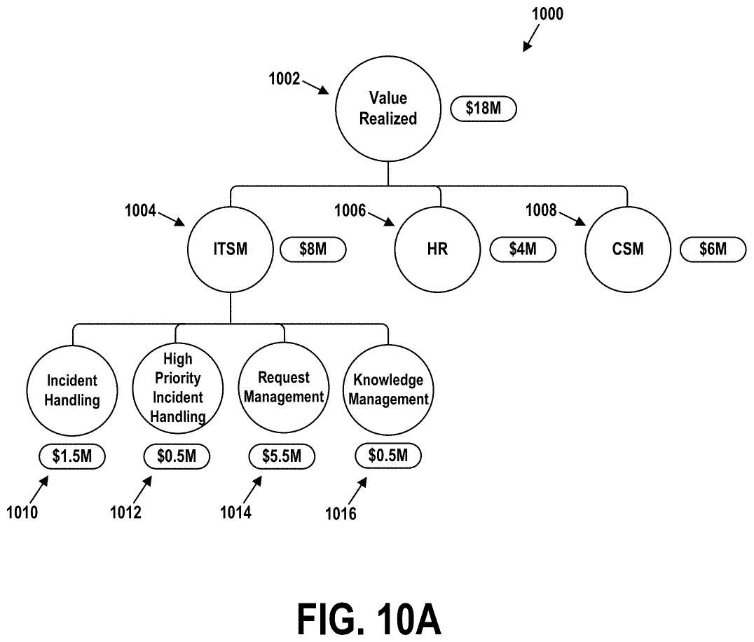

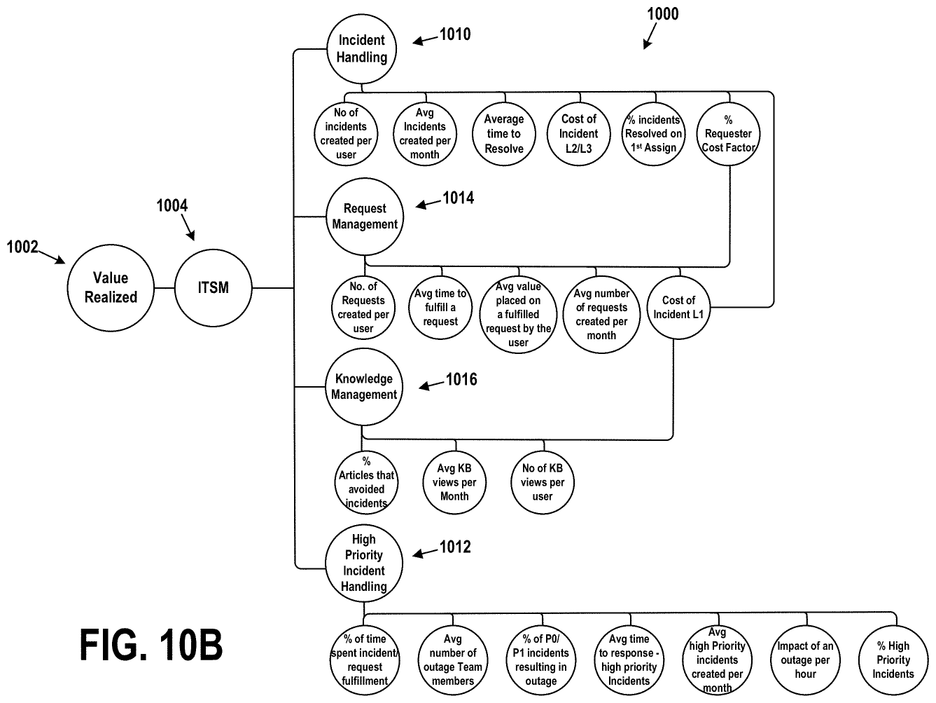

An example tree-like hierarchy 1000 for a number of application classes and applications is shown in FIG. 10A. Hub 1002 represents the present value of the system (e.g. across one or more computational instances) and is an aggregation (e.g., a sum, average or weighted average) of the present values associated with application class spokes 1004 (ITSM), 1006 (HR), and 1008 (CSM). In FIG. 10A for example, the application class ITSM is associated with $8 million, the application class HR is associated with $4 million, and the application class CSM is associated with $6 million. This sums to a system present value of $18 million for hub 1002. Here, ITSM stands for IT service management, HR stands for human resources, and CSM stands for customer service management.

ITSM application class spoke 1004, in turn, aggregates partial present values from application spokes 1010 (incident handling), 1012 (high-priority incident handling), 1014 (request management), and 1016 (knowledge management). In some cases, each application spoke may relate to a distinct application. In other cases, some application spokes may represent different features or usage patterns of the same application. For example, application spokes 1010 and 1012 may involve different features of the same incident handling application, while application spokes 1014 and 1016 may involve two distinct applications for request management and knowledge management, respectively.

Incident handling applications allow technology users to log IT-related incidents (e.g., software not operating properly, network outages, configuration issues). These applications may classify and then assign the incidents to IT personnel who endeavor to resolve the incidents. Incident handling efficiency is generally based on the volume of incidents, how long it takes to resolve incidents, the priority levels of the incidents, and how many IT personnel are involved in incident handling.

Request management applications allow users to request or order enterprise-related goods and services (e.g., mobile phones, computers, cloud-based storage, and so on). These applications may then use automated workflows to approve and fulfill the requests while keeping the requestors informed of the statuses of their respective requests. Request management efficiency is generally based on the volume of requests, how long it takes to fulfill requests, and the value that users place on fulfilled requests.

Knowledge management applications may be used to create and maintain knowledgebase articles. These articles may be manually or automatically written, and may provide self-service to users who are seeking to perform certain activities or understand certain technologies or processes. Knowledge management efficiency is generally based on how often the articles avoid incidents being created, are viewed, and number of article views per user.

In FIG. 10A, and again for purposes of example, incident handling application spoke 1010 is associated with a present value of $1.5 million, high-priority incident handling application spoke 1012 is associated with a present value of $0.5 million, request management application spoke 1014 is associated with a present value of $5.5 million, and knowledge management application spoke 1016 is associated with a present value of $0.5 million. This sums to the present value for the ITSM application class being $8 million.

Each of the application spokes may, in turn, calculate values from one or more respective feeder metrics. To that point, further detail for tree-like hierarchy 1000 is shown in FIG. 10B, focusing on ITSM-related feeder metrics that are ultimately aggregated by ITSM application class spoke 1004 and hub 1002. For example, the feeder metrics for incident handling application spoke 1010 include feeder metrics for the number of incidents created per user, average incidents created per month, average response time to resolve incidents, cost of incidents (in terms of layer 1 support), further cost of incidents (in terms of having to invoke layer 2 or 3 support), incidents resolved on first assignment, and percent requestor cost factor. Source data for each for these feeder metrics may be found in a database, such as database tables for an incident handling application that operates on the computational instance(s) under consideration. Alternatively or additionally, the source data may be found in other databases or locations, or may be manually entered.

In a similar fashion, feeder metrics for high-priority incident handling application spoke 1012, request management application spoke 1014, and knowledge management application spoke 1016 may rely on other sets of feeder metrics. Again, source data for each for these feeder metrics may also be found in databases, such as database tables for various applications that operate on the computational instance(s) under consideration. Alternatively or additionally, the source data may be found in other databases or locations, or may be manually entered.

Notably, cost of incidents (in terms of layer 1 support) is used as a feeder metric for multiple application spokes, notably application spokes 1010, 1014, and 1016. This illustrates that some source data can be re-used in various ways by different spokes.

Further, the exact arrangement of tree-like hierarchy 1000 can vary in different embodiments. Thus, in some cases, different sets of feeder metrics may be used as the basis of one or more application spokes. To that end, the embodiments of FIG. 10A and 10B are for purposes of example and can be modified in various ways.

TABLE 1

| App. | | | | | |
|---|---|---|---|---|---|
| Class | Application | | | Success | |
| Spoke | spoke | Feeder Metric | Description | Driver | Aggregation |
| ITSM | Incident | Number of | Ratio of number of | Minimize | Previous 12 Month |
| | Handling | incidents | incidents opened in a | | Average |
| | | created per user | month to the active user | | Last 12 Month Average |
| | | | count | | % Change |
| ITSM | Incident | % of incidents | Percentage of incidents | Maximize | Previous 12 Month |
| | Handling | resolved on first | resolved on first | | Average |
| | | assignment | assignment | | Last 12 Month Average |
| | | | (reassignment count = 0) | | % Change |
| ITSM | Incident | Avg. time to | The amount of time it | Minimize | Previous 12 Month Avg. |
| | Handling | resolve an | takes in hours to resolve | | Last 12 Month Avg. |
| | | incident (Hrs) | an incident | | % Change |
| ITSM | Incident | Average | 12 month average of | Minimize | Previous 12 Month Avg. |
| | Handling | number of | number of incidents | | Last 12 Month Avg. |
| | | incidents per | created per month | | % Change |
| | | month | | | |
| ITSM | High Priority | % of high | Percentage incidents | Minimize | Previous 12 Month Avg. |
| | Incident | priority | resolved as priority 0 | | Last 12 Month Avg. |
| | Handling | incidents | (P0) or priority 1 (P1) | | % Change |
| | | | type | | |
| ITSM | High Priority | Avg. time to | Average time it takes to | Minimize | Previous 12 Month Avg. |
| | Incident | resolve a high | resolve a high priority | | Last 12 Month Avg. |
| | Handling | priority incident | (P0/P1) type incident | | % Change |
| | | (Hrs) | | | |
| ITSM | High Priority | Avg. high | 12-month average of | Minimize | Previous 12 Month Avg. |
| | Incident | priority | high priority (P0/P1) | | Last 12 Month Avg. |
| | Handling | incidents | type of incidents created | | % Change |
| | | created per | per month | | |
| | | month | | | |
| ITSM | Request | Avg. number of | Average of 12 months | Maximize | Previous 12 Month Avg. |
| | Management | requests created | cumulative data of | | Last 12 Month Avg. |
| | | per month | number of requests | | % Change |
| | | | created | | |
| ITSM | Request | Avg. time to | Average time to fulfill a | Minimize | Previous 12 Month Avg. |
| | Management | fulfill a request | requests in hours. | | Last 12 Month Avg. |
| | | (Hrs) | | | % Change |
| ITSM | Request | Number of | Ratio of number of | Maximize | Previous 12 Month Avg. |
| | Management | requests created | requests created to the | | Last 12 Month Avg. |
| | | per user | Active User count | | % Change |
| ITSM | Knowledge | Avg. number of | 12- Month average of | Maximize | Previous 12 Month Avg. |
| | Management | knowledge | knowledge article views | | Last 12 Month Avg. |
| | | article views | per month | | % Change |
| | | per month | | | |
| ITSM | Knowledge | Number of | Ratio of knowledge | Maximize | Previous 12 Month Avg. |
| | Management | knowledge base | article views to the | | Last 12 Month Avg. |
| | | views per user | active user count | | % Change |
| ITSM | General | Active user | Count of unique active users on a | Maximize | NA |
| | | count | computational instance | | |
| | | | over 365 days | | |

Further detail regarding the feeder metrics for the ITSM application class spoke 1004 is shown in Table 1. These feeder metrics are based on data sources 702, were generated by various applications of the ITSM application class, and can be represented as integer or real (decimal) numbers. Feeder metrics based on parameters 704 are shown below. Table 1 does not include all feeder metrics based on data sources 702, and others may exist.

In table 1, each feeder metric is characterized in terms of its application class (here, ITSM), application (incident handling, high priority incident handling, request management, knowledge management), the feeder metric, a description of the metric, how success is measured for the metric (e.g., is the goal to maximum or minimize the metric), and aggregation (the time period under consideration, over which the data is aggregated). For example, the feeder metric “number of incidents created per user” is used by the incident handling application spoke, and is calculated as the ratio of number of incidents opened in a month to the active user count. The goal is to minimize this feeder metric, and aggregation occurs over a 12-month period. In alternative embodiments, a 1-month, 3-month, or 6-month period could be used. Other periods are possible as well.

TABLE 2

| Parameter | Type | Description | Spoke Affinity |
|---|---|---|---|
| Impact of outage per hour | Currency | Estimated cost per hour for a | ITSM: High Priority |
| | | major outage (P0/P1 incident) | Incident Handling |
| % of PO/P1 incidents resulting | Decimal | Estimated percentage of monthly | ITSM: High Priority |
| in an outage | | P0/P1 incident volume resulting | Incident Handling |
| | | in an outage | |
| % of time spent on incident/ | Decimal | Percentage of total resolution | ITSM: High Priority |
| request (activity time − fulfiller | | time (cycle time) that was worked | Incident Handling |
| working hours) | | on the incident | |
| Avg. number of high priority | Decimal | Average number of people | ITSM: High Priority |
| outage team members | | involved in solving high priority | Incident Handling |
| | | outages (crisis or SWAT team) | |
| High priority outage handling | Currency | Estimated loaded hourly labor | ITSM: High Priority |
| labor hourly rate | | rate for handling a high priority | Incident Handling |
| | | outage | |
| Cost of incident at support level | Currency | Estimated cost per ticket at L1 | ITSM: Incident Handling |
| L1 | | (Per HDI ~$22) | ITSM: Request |
| | | | Management |
| | | | ITSM: Knowledge |
| | | | Management |
| Cost of incident at support level | Currency | Estimated cost per ticket at L2/L3 | ITSM: Incident Handling |
| L2/L3 | | (Per HDI ~$69) | |
| % Requester cost factor | Decimal | Request or downtime as % of cost | ITSM: Incident Handling |
| | | for incident or request [110% | ITSM: Request |
| | | value means (110%) of | Management |
| | | $25 = $27.5 requester downtime | |
| | | per incident] | |
| % user productivity | Decimal | Estimated percentage of requestor | ITSM: Request |
| improvement per request | | effort reduction per fulfilled | Management |
| | | request | |
| Average cost to fulfill a request | Currency | Estimated average cost involved | ITSM: Request |
| | | in fulfilling a request | Management |
| Average value placed on a | Currency | Average benefit realized per | ITSM: Request |
| fulfilled request by the | | fulfilled request | Management |
| requestor | | | |
| % of KB articles that avoided | Decimal | Estimated percentage of | ITSM: Knowledge |
| incidents | | beneficial KB article views | Management |
| | | [incident deflection] | |

Additional detail regarding the feeder metrics for the ITSM application class spoke 1004 is shown in Table 2. These feeder metrics are based on parameters 704 and can be represented as real (decimal) numbers or currency values (e.g., dollars). As noted, parameters are generally set by an administrator or user of the computational instance, and thus may be estimates or approximations of values that would otherwise be difficult or impossible to calculate programmatically. In other cases, parameters might be based on collected data or estimated using machine learning techniques. Table 2 does not include all feeder metrics that are based on parameters 704, and others may exist.

In Table 2, each feeder metric is characterized in terms of its parameter name, type (e.g., decimal or currency), description, and the application spokes that uses it. For example, the parameter “average value placed on a fulfilled request by the requestor” is of the currency type, represents an average benefit realized per fulfilled request, and is used by request management application spoke 1014. This value may be estimated to be, for instance, $25 in cost savings.

TABLE 3

| Application | Application | |
|---|---|---|
| Spoke | spoke | Formula |
| ITSM | Incident Handling | Estimated Cost over Last 12 Months (Incident Handling) = Cost of Incidents |
| | (Estimated Cost | per Month * 12 Months + Requester Productivity Savings per Month * 12 |
| | over last 12 | Months |
| | Months) | |
| | | @ Cost of Incidents per Month = (Number of Incidents created per User * |
| | | Number of Users * Percentage of Incidents Resolved on First Assignment * |
| | | Cost of Incident at Support Level L1) + (Number of Incidents created per |
| | | User * Number of Users * (1 − Percentage of Incidents Resolved on First |
| | | Assignment) * Cost of Incident at Support Level L2/3) |
| | | @ Requester Productivity Savings per Month = Avoided Incidents * % |
| | | Requester Cost Factor * Cost of Incident at Support Level L1 |
| ITSM | High Priority | Estimated Cost over Last 12 Months (High Priority Incident Handling) = |
| | Incident Handling | Labor cost avoidance * 12 months + Cost Avoidance * 12 months |
| | (Estimated Cost | (@Labor cost avoidance per month = average number of high priority |
| | over last 12 | incidents per month * average time to resolve a high priority incident * |
| | Months) | average number of high priority outage team members * high priority outage |
| | | handling labor hourly rate |
| | | @ Cost Avoidance per month = average number of high priority incidents |
| | | per month * average time to resolve a high priority incident * impact of |
| | | outage per hour) |
| ITSM | Request | Estimated Cost over Last 12 Months (Request Management) = Net Value |
| | Management | realized in fulfilling additional requests * 12 months + Total Request |
| | (Estimated Cost | Fulfilment Cost * 12 months + Requestor Productivity Improvement |
| | over last 12 | (@Net Value Realized by fulfilling Additional Requests per month = |
| | Months) | (Average Value placed on a Fulfilled Request by the Requestor − (Average |
| | | Cost to Fulfill a Request + Cost of Requester Downtime per Request)) * |
| | | Additional Requests per Month |
| | | @Total request fulfilment cost per month = Average Cost to Fulfil a Request |
| | | * Average requests created per month |
| | | @Requestor Productivity Improvement = Cost of Requestor Downtime per |
| | | Request * User Productivity Improvement per Request * Average requests |
| | | created per month) |
| ITSM | Knowledge | Estimated Cost over Last 12 Months (Knowledge Management) = Incident |
| | Management | cost avoidance * 12 months |
| | (Estimated Cost | (@Incident cost avoidance per month = Avg. Number of Knowledge Article |
| | over last 12 | Views per Month * % of KB Articles that Avoided Incidents * Cost of |
| | Months) | Incident at Support Level L1) |
| ITSM | N/A | SUM [(Previous Incident Handling − Current Incident Handling), (Previous |
| | (Estimated Cost | High Priority Incident Handling − Current High Priority Incident Handling), |
| | Savings over last | (Previous Request Management − Current Request Management), (Previous |
| | 12 Months) | Knowledge Management − Current Knowledge Management)] |

Table 3 defines the calculations that may be performed for application class spoke 1004 as well as application spokes 1010, 1012, 1014, and 1016. Each of application spokes 1010, 1012, 1014, and 1016 rely on one or more of data sources from Table 1 and/or parameters from Table 2. Any variables or values that appear in Table 3 that are not described in Tables 1 or 2 may be further parameters that are estimated and/or otherwise supplied by an administrator or user of the computational instance(s). The calculations provided in Table 3 are for purposes of example. Other calculations are possible.

For instance, these calculations are shown for a 12-month period, but could be performed for periods of other durations. Further, these calculations may be performed for both current and previous data, where the actual savings or benefit is the difference between the two. For example, see the calculations in the final row of Table 3.

As an example, the second row of Table 3 provides a formula for calculating the estimated cost savings over the last 12 months provided by high priority incident handling. This is the sum of labor cost avoidance over 12 months and other cost avoidance over 12 months. Labor cost avoidance per month is the product of: (i) average number of high priority incidents per month (Table 1), (ii) average time to resolve a high priority incident (Table 1), (iii) average number of high priority outage team members (Table 2), and (iv) high priority outage handling labor hourly rate (Table 2). Other cost avoidance per month is the product of the (i) average number of high priority incidents per month (Table 1), (ii) average time to resolve a high priority incident (Table 1), and (iii) impact of outage per hour (Table 2).

Thus, the telemetry application can scan the computational instance(s) to determine the values in Table 1 and then apply the parameters from Table 2 to determine the cost savings due to use of the high priority incident handling application on the computational instance(s). As shown in Table 3, similar calculations may occur for the other applications.

The final row of Table 3 sums the calculations for each of application spokes 1010, 1012, 1014, and 1016 into an estimated annual cost savings attributable to using the computational instance(s) for high-priority incident handling. Since the feeder metrics of Tables 1 and 2 are in terms of monthly values, they can be multiplied by 12 to produce estimates of annual values.

The calculations defined in tree-like hierarchy 1000 may be performed in a bottom-up fashion so that present values for application spokes are calculated before the present values for application class spokes. Further, the present values for application class spokes may be calculated before the present value of the system as a whole. Nonetheless, the result of these calculations represents a present value that applications of the computational instance(s) provide to the enterprise based on current usage patterns. This present value can be compared to the present values of other enterprises of similar size and market to estimate how the enterprise matches up to its peers.

### VII. Modeling Potential Value

Potential value calculations are based on a similarly-structured model as that of present value, and may make use of the present value calculations at various levels of tree-like hierarchy 1000, for example. But unlike present value, potential value estimates how much additional value that an enterprise may be able to obtain through further use or better usage of the applications on its computational instance(s).

Particularly, the potential value hub and spokes consume the same or similar set of feeder metrics as for the present value model, but with an additional dimension. This dimension represents the present values for different peer systems (i.e., computational instances of other enterprises in similar markets). A distribution of these values is determined, and each enterprise's present value will be associated with a percentile based on where that present value falls in the distribution. For example, a particular present value that is higher than 47% of the other present values but lower than 53% of the other present values will have a percentile of 47%.

The peer groups may be manually determined based on enterprise size (in terms of employee count and/or revenue), market segment, or other factors. In some cases, the peer groupings may be automatically suggested by a remote network management platform based on data obtained from its respective computational instances.

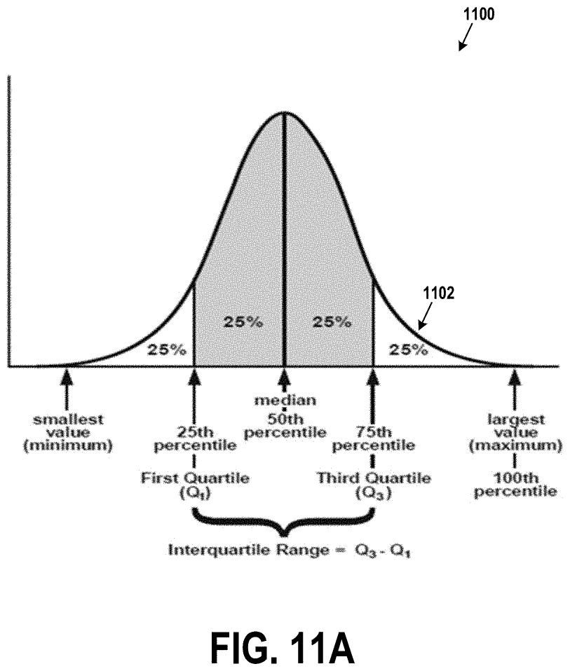

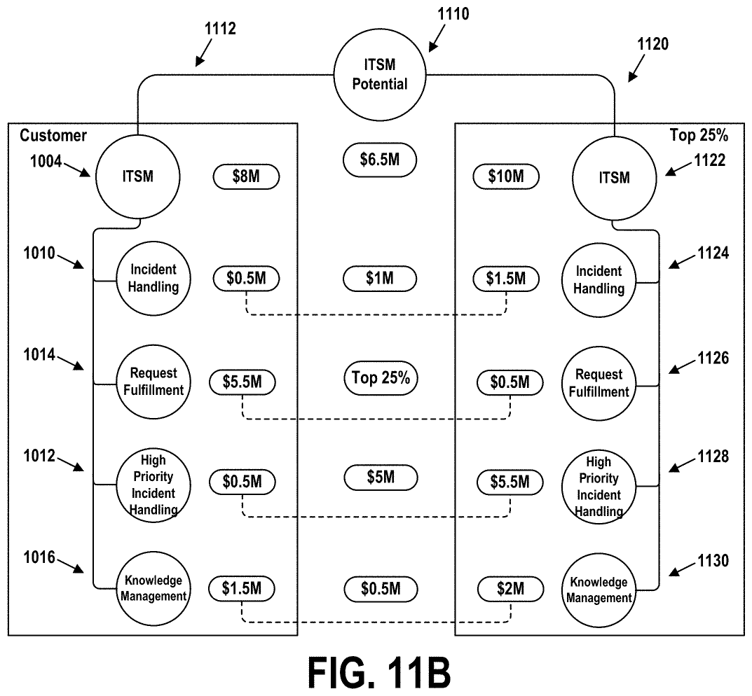

As an example, chart 1100 of FIG. 11A shows a normal distribution for present values. The x-axis represents the percentile and the y-axis represents the relative number of present values at the percentile. Also shown are the quartiles of the distribution, including the upper quartile 1102 that falls between the 75th and 100th percentiles. Present values may take on distributions other than a normal distribution in some cases. The distribution of present value may be re-generated on a monthly basis (or at another frequency) to facilitate peer comparison.

Incorporating such data enables the telemetry application to develop insights in terms of where an enterprise is positioned compared to its peers; namely, the quartile in which it exists in terms of value that it derives from its computational instance(s). An enterprise with a present value that is within the upper quartile is considered to a top performer with relatively little room for improvement of its present value. An enterprise with a present value not within the upper quartile is considered to have room to improve its present value.

Potential value, in short, can be calculated based on a difference between where an enterprise falls in such a present value distribution and the upper quartile of this distribution. For example, suppose that an enterprise is ranked at the median and has a calculated present value of $5 million dollars. Suppose further that enterprises in the upper quartile have an average present value of $8 million. In this case, the shortfall is $3 million. For enterprises in the upper quartile, potential value might be set to zero or based on a comparison between their present values and the average present value of enterprises above them in the distribution. Regardless, potential value represents the unused potential of an enterprise's computational instance(s).

Potential value can also be modeled as a calculation hub that is made up of a number of application class spokes. Each application class spoke has further application spokes that perform calculations based on a defined set of feeder metrics and parameters. As was the case for present value calculations, the application spokes provide values (e.g. in dollars, other currency, or in accordance with some other metric) that the related applications are estimated to provide to users of the computational instance. Such application spokes can be combined in various manners by the telemetry application to determine the potential value.

An example is shown in FIG. 11B. The potential value associated with ITSM hub 1110 for a particular enterprise is based on a comparison between: (i) the present values calculated, for that enterprise, of application spokes that feed into ITSM application class spoke 1004, and (ii) representations of the present values calculated for these application spokes across all enterprises within the top quartile of overall present value. The representations may be averages, medians, or some other measure of the values for enterprises in the top quartile. These representations may be characterized by or otherwise associated with ITSM application class spoke 1122. Non-ITSM application classes are omitted from FIG. 11B for sake of simplicity, but could be used in the potential value model.

For example, incident handling application spoke 1010 may determine that there is a present value of $0.5 million due to the use of the incident handling application for the particular enterprise. Further, incident handling application spoke 1124 determines that there is an average present value of $1.5 million due to the use of the incident handling application across all enterprises in the top quartile. The difference between these two values (e.g., average present value for all enterprises in the top quartile minus present value for the particular enterprise) is a potential value of $1 million as shown in FIG. 11B.

A similar difference can be determined between high-priority incident handling application spoke 1012 (for the particular enterprise) and high-priority incident handling application spoke 1128 (across all enterprises). The difference is a potential value of $5 million as shown in FIG. 11B. Another similar difference can be determined between knowledge management application spoke 1016 (for the particular enterprise) and knowledge management application spoke 1130 (across all enterprises). The difference is a potential value of $0.5 million as shown in FIG. 11B.

In contrast, the present value for request management application spoke 1014 is $5 million greater than the average present value for application spoke 1128 across all enterprises in the top quartile. Thus, the particular enterprise is already in the top quartile for request management, and the potential value for this factor is set to zero. As a consequence, the total potential value as represented by ITSM hub 1110 is $6.5 million even though the overall differences between present values aggregated in ITSM application class spoke 1004 and ITSM application class spoke 1122 is $2 million.

TABLE 4

| Application | | |
|---|---|---|
| Class | Application | |
| Spoke | Spoke | Formula |
| ITSM | Incident Handling | Max ([Top Quartile Cost Savings] − [Estimated Cost Savings over last 12 |
| | | Months], 0) |
| ITSM | High Priority | Max ([Top Quartile Cost Savings] − [Estimated Cost Savings over last 12 |
| | Incident Handling | Months], 0) |
| ITSM | Request | Max ([Top Quartile Cost Savings] − [Estimated Cost Savings over last 12 |
| | Management | Months], 0) |
| ITSM | Knowledge | Max ([Top Quartile Cost Savings] − [Estimated Cost Savings over last 12 |
| | Management | Months], 0) |
| ITSM | N/A | SUM [Incident Handling, High Priority Incident Handling, Request |
| | | Management, Knowledge Management] |

Table 4 illustrates example difference calculations for the ITSM applications. Specifically, for each of incident handling, high priority incident handling, request management, and knowledge management, the difference between the cost savings of enterprises in the top quartile and that of the particular enterprise is calculated. Then the maximum of each difference and zero is determined as the respective potential values. The sum of these results is used as the potential value for the ITSM application class.

### VIII. Modeling Digital Maturity

The digital maturity value for an enterprise provides a percentage that represents the level of digitization for the enterprise based on use of its computational instances. Particularly, digital maturity is evaluated from the reach, workloads, and automation of applications on these computational instances.

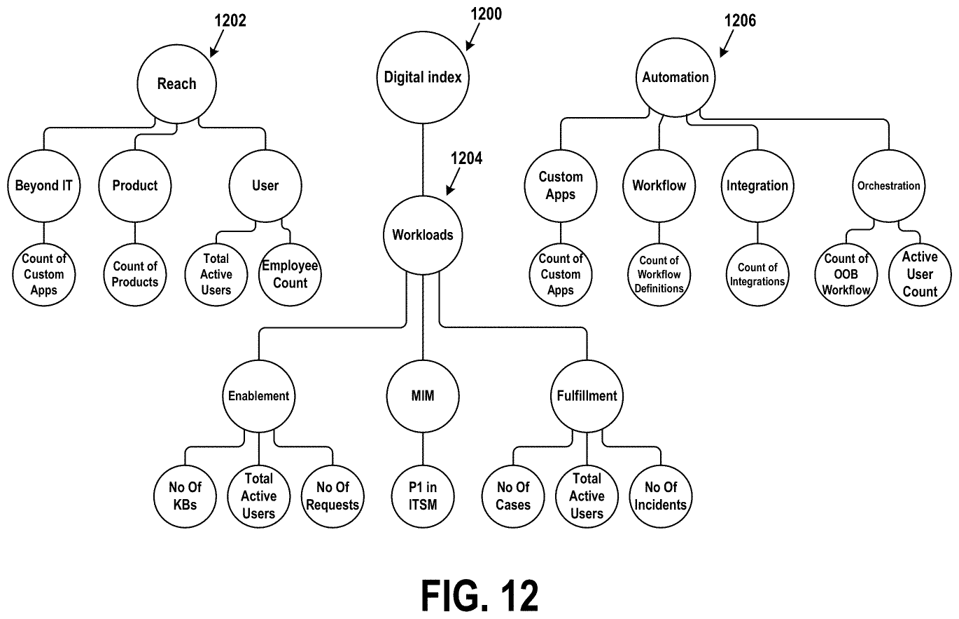

A visual representation of the factors and feeder metrics used for each is shown in FIG. 12. Notably, digital index 1200 is calculated based on reach 1202, workloads 1204, and automation 1206. Reach 1202 measures the volume of computational instance use by the enterprise, and incorporates counts of active users, employees, applications that the enterprise uses on the computational instance(s), and custom applications that the enterprise has developed on the computational instance(s). Workloads 1204 measure the utilization of key applications, such as the incident management, request management, and knowledge management applications. Automation 1206 measures the enterprise's use of the computational instance(s) for workflows, custom applications, orchestrations (automating a number of application actions), and integrations (e.g., operational linkages between an application on the computational instance and a third-party service), incorporating counts of each. Again, some feeder metrics may be used by more than one spoke.

TABLE 5

| Spoke | Child Spoke | Feeder Metrics | Weight |
|---|---|---|---|
| Reach | User | Total Active Users/Companies | 10% |
| | | Employee Count | |
| | Product | Count of key application (ITSM, CSM, | 5% |
| | | HR, etc.) use | |
| | Beyond IT | Count of Custom Applications and Non | 5% |
| | | ITSM products | |
| Workloads | Enablement | Requests and Knowledge per Active | 25% |
| | | User Count | |
| | Fulfilment | Incidents and Cases per Active User | 25% |
| | | Count | |
| | Major Incident Mgmt. | P1 Incidents Usage | 5% |
| Automation | Workflow | Count of Workflow Definitions | 5% |
| | Orchestration | Count of Orchestrations per Active | 5% |
| | | User Count | |
| | Custom Applications | Count of Custom Applications | 10% |
| | Integrations | Integrations between an application on | 5% |
| | | the computational instance and a third- | |
| | | party service | |

Table 5 describes each of reach 1202, workloads 1204, and automation 1206 along with weights given to their respective feeder metrics. Further, each feeder metric is assigned a point value between 1 and 15 based on where it falls in a distribution across all enterprises. The point value for each is multiplied by its corresponding weight and the results are used to determine digital maturity scores for each of reach 1202, workloads 1204, and automation 1206, as well as the enterprise as a whole.

TABLE 6

| Distribution % for feeder metric | Points |
|---|---|
| 0 | 0 |
| >0 to <=20 | 1 |
| >20 to <=40 | 3 |
| >40 to <=60 | 5 |
| >60 to <=70 | 7 |
| >70 to <=80 | 9 |
| >80 to <=90 | 11 |
| >90 | 15 |

The assignment of points to percentiles is shown in FIG. 6. For each feeder metric, its percentile across all enterprises is determined, and then the corresponding number of points is assigned. Here, the range of point values are from 0 to 15, but other ranges could be used.

TABLE 7

| Spoke | Child Spoke | % Rank | Points | Weight | Score | Overall |
|---|---|---|---|---|---|---|
| Reach | User | 27 | 3 | 10% | 0.30 | 0.8/3 |
| | Product | 46 | 5 | 5% | 0.25 | 26% |
| | Beyond IT | 50 | 5 | 5% | 0.25 | |
| Workloads | Enablement | 71 | 9 | 25% | 2.25 | 5.35/8.25 |
| | Fulfilment | 82 | 11 | 25% | 2.75 | 65% |
| | MIM | 67 | 7 | 5% | 0.35 | |
| Automation | Workflow | 77 | 9 | 5% | 0.45 | 0.95/4.50 |
| | Orchestration | 23 | 3 | 5% | 0.15 | 21% |
| | Custom Apps | 15 | 1 | 10% | 0.10 | |
| | Integration | 45 | 5 | 5% | 0.25 | |

| | |
|---|---|
| Digital Index Score | 7.10/15.75 |
| | 45% |

An example that illustrates the use of points is shown in Table 7. For an enterprise, the user spoke (representing total active users and an employee count for the enterprise) has a rank of 27%. In accordance with Table 6, this gives the user spoke 3 points. The user spoke also has a weight of 10%, which is multiplied by the 3 points to get a score of 0.3. The product spoke (representing a count of applications used by the enterprise) has a rank of 46%. In accordance with Table 6, this gives the product spoke 5 points. The user spoke also has a weight of 5%, which is multiplied by the 5 points to get a score of 0.25. The beyond IT spoke (representing a count of custom applications developed by the enterprise) has a rank of 50%. In accordance with Table 6, this gives the beyond IT spoke 5 points. The beyond IT spoke also has a weight of 5%, which is multiplied by the 5 points to get a score of 0.25.

These three scores are summed to a total of 0.8 for the reach spoke. The maximum sum of scores for the reach spoke is 3.0, so the reach spoke has achieved only 26% of this potential.

Similar calculations can be performed for the workloads spoke and the automation spoke, resulting in scores of 5.35/8.25 (65%) and 0.95/4.50 (21%), respectively. The sum of these scores is 7.10/15.75, representing an overall digital maturity for the enterprise of 45%. This indicates that there are a number of areas that the enterprise can focus on to improve its digital maturity, such as increasing user utilization of the computational instance(s) and developing more custom applications and integrations, as well as making heavier use of the incident management, high-priority incident management, request management, and knowledge management applications.

TABLE 8

| Driver Area | Insights |
|---|---|
| Reach (26%) | Enterprise usage of the platform is the lower quartile and although they are |
| | committed in using a number of applications that are not just IT focused, it is |
| | evident that the platform is only reaching a small part of the enterprise's |
| | employee base. |
| Workloads (65%) | Managing workloads through the platform is positive with a high score in |
| | fulfilment of work, where the enterprise is using the platform efficiently. |
| Automation (21%) | The enterprise is ranked in the lowest percentage for automation and this is a |
| | definite focus area of improvement especially around orchestration. There is |
| | much potential to automate processes and manual tasks as well as leveraging |
| | custom applications. |
| Overall (45%) | Compared to its peers, the enterprise has a great opportunity to drive more |
| | digitization through digital initiatives such as orchestration and building |
| | custom workflows. However, there is also significant potential to drive great |
| | employee experiences and increase the usage of the platform. |

Examples recommendations for each of reach, workloads, automation, and an overall assessment can be automatically generated based on an enterprises scores. For example, Table 8 contains plain language descriptions of where the enterprise is performing well and underperforming. Further, these descriptions can make concrete and specific suggestions as to how the enterprise can improve its digital maturity.

### IX. Example Operations

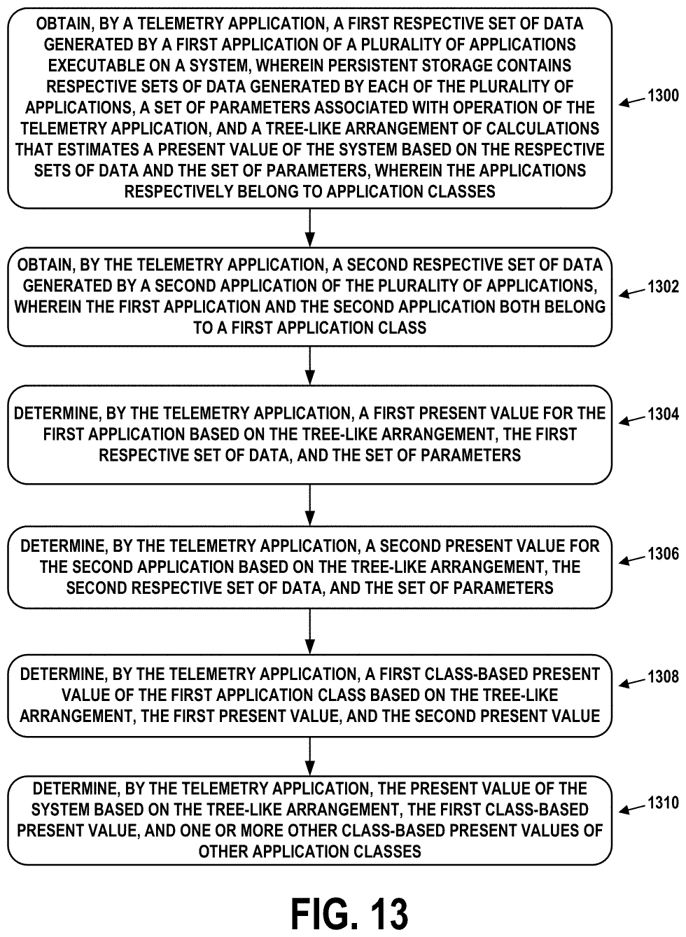

FIG. 13 is a flow chart illustrating an example embodiment. The process illustrated by FIG. 13 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 13 may be simplified by the removal of any one or more of the features shown therein. Further, these embodiments may be combined with features, aspects, and/or implementations of any of the previous figures or otherwise described herein.

Block 1300 may involve obtaining, by a telemetry application, a first respective set of data generated by a first application of a plurality of applications executable on a system, wherein persistent storage contains respective sets of data generated by each of the plurality of applications, a set of parameters associated with operation of the telemetry application, and a tree-like arrangement of calculations that estimates a present value of the system based on the respective sets of data and the set of parameters, wherein the applications respectively belong to application classes.

Block 1302 may involve obtaining, by the telemetry application, a second respective set of data generated by a second application of the plurality of applications, wherein the first application and the second application both belong to a first application class.

Block 1304 may involve determining, by the telemetry application, a first present value for the first application based on the tree-like arrangement, the first respective set of data, and the set of parameters.

Block 1306 may involve determining, by the telemetry application, a second present value for the second application based on the tree-like arrangement, the second respective set of data, and the set of parameters.

Block 1308 may involve determining, by the telemetry application, a first class-based present value of the first application class based on the tree-like arrangement, the first present value, and the second present value.

Block 1310 may involve determining, by the telemetry application, the present value of the system based on the tree-like arrangement, the first class-based present value, and one or more other class-based present values of other application classes.

In some embodiments, at least part of the first respective set of data is stored in one or more database tables associated with the first application, wherein at least part of the second respective set of data is stored in one or more database tables associated with the second application.

In some embodiments, at least part of the first respective set of data is stored in one or more log files associated with the first application, and wherein at least part of the second respective set of data is stored in one or more log files associated with the second application.

Some embodiments may further involve obtaining a third respective set of data generated by a third application of the plurality of applications, wherein the third application belongs to a second application class; determining a third present value for the third application based on the tree-like arrangement, the third respective set of data, and the set of parameters; and determining a second class-based present value of the second application class based on the tree-like arrangement and the third present value, wherein the one or more other class-based present values of other application classes include the second class-based present value.

Some embodiments may further involve determining, for the first application, a first distribution of present values across multiple systems; comparing the first present value to the first distribution of present values; possibly based on comparing the first present value to the first distribution of present values, determining, for the first application, a first potential value; determining, for the second application, a second distribution of present values across multiple systems; comparing the second present value to the second distribution of present values; possibly based on comparing the second present value to the second distribution of present values, determining, for the second application, a second potential value; determining a class-based potential value of the first application class based on the tree-like arrangement, the first potential value, the second potential value, and the set of parameters; and determining a potential value of the system based on the tree-like arrangement, the class-based potential value, and one or more other class-based potential values of other application classes.

In some embodiments, comparing the first present value to the first distribution of present values comprises determining a difference between (i) a set of present values in a top quartile of the first distribution of present values and (ii) the first present value, wherein determining the first potential value comprises setting the first potential value to the difference when the difference is greater than zero or setting the first potential value to zero otherwise.

In some embodiments, determining the difference between (i) the set of present values in the top quartile of the first distribution of present values and (ii) the first present value comprises determining the difference to be between (i) an average of the set of present values in the top quartile of the first distribution of present values and (ii) the first present value.

In some embodiments, the persistent storage also contains digital maturity metrics representing usage of the system by users, key applications used by the users, custom applications deployed on the system, usage of the first application, usage of the second application, workflow definitions, orchestrations, and integrations, wherein the digital maturity metrics are respectively associated with weights. These embodiments may further involve obtaining distributions of the digital maturity metrics across multiple systems; possibly based on the distributions and a pre-defined table, assigning points to each of the digital maturity metrics; multiplying the points for each of the digital maturity metrics by its associated weight to determine respective scores for the digital maturity metrics; and determining an overall digital maturity score for the system based on the respective scores.

Some embodiments may further involve, possibly based on the respective scores and the overall digital maturity score, generating a set of textual recommendations suggesting how the system can improve its digital maturity.

In some embodiments, a reach factor of the overall digital maturity score is based on the usage of the system by users, the key applications used by the users, and the custom applications deployed on the system, wherein a workloads factor of the overall digital maturity score is based on the usage of the first application and the usage of the second application, wherein an automation factor of the overall digital maturity score is based on the workflow definitions, orchestrations, integrations, and the custom applications deployed on the system, and wherein digital maturity sub-scores are determined for each of the reach factor, the workloads factor, and the automation factor.

In some embodiments, the first application and the second application are selected from the group consisting of an incident management application, a high-priority incident management application, a request management application, and a knowledgebase application.

### X. Closing

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of computer readable medium such as a storage device including RAM, a disk drive, a solid state drive, or another storage medium.

The computer readable medium can also include non-transitory computer readable media such as computer readable media that store data for short periods of time like register memory and processor cache. The computer readable media can further include non-transitory computer readable media that store program code and/or data for longer periods of time. Thus, the computer readable media may include secondary or persistent long term storage, like ROM, optical or magnetic disks, solid state drives, or compact-disc read only memory (CD-ROM), for example. The computer readable media can also be any other volatile or non-volatile storage systems. A computer readable medium can be considered a computer readable storage medium, for example, or a tangible storage device.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

1. A system comprising:
persistent storage containing respective sets of data generated by each of a plurality of applications executable on the system, a set of parameters of a telemetry application, and a tree-like arrangement of calculations that estimates a present value of the system based on the respective sets of data and the set of parameters, wherein the applications respectively belong to application classes; and
one or more processors configured to:
obtain, by the telemetry application, a first respective set of data generated by a first application of the plurality of applications;
obtain, by the telemetry application, a second respective set of data generated by a second application of the plurality of applications, wherein the first application and the second application both belong to a first application class;
determine, by the telemetry application, a first present value for the first application based on the tree-like arrangement, the first respective set of data, and the set of parameters of the telemetry application;
determine, by the telemetry application, a second present value for the second application based on the tree-like arrangement, the second respective set of data, and the set of parameters of the telemetry application;
determine, by the telemetry application, a first class-based present value of the first application class based on the tree-like arrangement, the first present value, and the second present value; and
determine, by the telemetry application, the present value of the system based on the tree-like arrangement, the first class-based present value, and one or more other class-based present values of other application classes.

2. The system of claim 1, wherein at least part of the first respective set of data is stored in one or more database tables associated with the first application, and wherein at least part of the second respective set of data is stored in one or more database tables associated with the second application.

3. The system of claim 1, wherein at least part of the first respective set of data is stored in one or more log files associated with the first application, and wherein at least part of the second respective set of data is stored in one or more log files associated with the second application.

4. The system of claim 1, wherein the one or more processors are further configured to cause the telemetry application to:
obtain a third respective set of data generated by a third application of the plurality of applications, wherein the third application belongs to a second application class;
determine a third present value for the third application based on the tree-like arrangement, the third respective set of data, and the set of parameters; and
determine a second class-based present value of the second application class based on the tree-like arrangement and the third present value, wherein the one or more other class-based present values of other application classes include the second class-based present value.

5. The system of claim 1, wherein the one or more processors are further configured to cause the telemetry application to:
determine, for the first application, a first distribution of present values across multiple systems;
compare the first present value to the first distribution of present values;
based on comparing the first present value to the first distribution of present values, determine, for the first application, a first potential value;
determine, for the second application, a second distribution of present values across multiple systems;
compare the second present value to the second distribution of present values;
based on comparing the second present value to the second distribution of present values, determine, for the second application, a second potential value;
determine a class-based potential value of the first application class based on the tree-like arrangement, the first potential value, the second potential value, and the set of parameters; and
determine a potential value of the system based on the tree-like arrangement, the class-based potential value, and one or more other class-based potential values of other application classes.

6. The system of claim 5, wherein comparing the first present value to the first distribution of present values comprises determining a difference between (i) a set of present values in a top quartile of the first distribution of present values and (ii) the first present value, and wherein determining the first potential value comprises setting the first potential value to the difference when the difference is greater than zero or setting the first potential value to zero otherwise.

7. The system of claim 6, wherein determining the difference between (i) the set of present values in the top quartile of the first distribution of present values and (ii) the first present value comprises:
determining the difference to be between (i) an average of the set of present values in the top quartile of the first distribution of present values and (ii) the first present value.

8. The system of claim 1, wherein the persistent storage also contains digital maturity metrics representing usage of the system by users, key applications used by the users, custom applications deployed on the system, usage of the first application, usage of the second application, workflow definitions, orchestrations, and integrations, wherein the digital maturity metrics are respectively associated with weights, and wherein the one or more processors are further configured to cause the telemetry application to:
obtain distributions of the digital maturity metrics across multiple systems;
based on the distributions and a pre-defined table, assign points to each of the digital maturity metrics;
multiply the points for each of the digital maturity metrics by its associated weight to determine respective scores for the digital maturity metrics; and
determine an overall digital maturity score for the system based on the respective scores.

9. The system of claim 8, wherein the one or more processors are further configured to cause the telemetry application to:
based on the respective scores and the overall digital maturity score, generate a set of textual recommendations suggesting how the system can improve its digital maturity.

10. The system of claim 8, wherein a reach factor of the overall digital maturity score is based on the usage of the system by users, the key applications used by the users, and the custom applications deployed on the system, wherein a workloads factor of the overall digital maturity score is based on the usage of the first application and the usage of the second application, wherein an automation factor of the overall digital maturity score is based on the workflow definitions, orchestrations, integrations, and the custom applications deployed on the system, and wherein digital maturity sub-scores are determined for each of the reach factor, the workloads factor, and the automation factor.

11. The system of claim 1, wherein the first application and the second application are selected from the group consisting of an incident management application, a high-priority incident management application, a request management application, and a knowledgebase application.

12. A computer-implemented method comprising:
obtaining, by a telemetry application, a first respective set of data generated by a first application of a plurality of applications executable on a system, wherein persistent storage contains respective sets of data generated by each of the plurality of applications, a set of parameters of the telemetry application, and a tree-like arrangement of calculations that estimates a present value of the system based on the respective sets of data and the set of parameters, and wherein the applications respectively belong to application classes;
obtaining, by the telemetry application, a second respective set of data generated by a second application of the plurality of applications, wherein the first application and the second application both belong to a first application class;
determining, by the telemetry application, a first present value for the first application based on the tree-like arrangement, the first respective set of data, and the set of parameters of the telemetry application;
determining, by the telemetry application, a second present value for the second application based on the tree-like arrangement, the second respective set of data, and the set of parameters of the telemetry application;
determining, by the telemetry application, a first class-based present value of the first application class based on the tree-like arrangement, the first present value, and the second present value; and
determining, by the telemetry application, the present value of the system based on the tree-like arrangement, the first class-based present value, and one or more other class-based present values of other application classes.

13. The computer-implemented method of claim 12, further comprising:
obtaining a third respective set of data generated by a third application of the plurality of applications, wherein the third application belongs to a second application class;
determining a third present value for the third application based on the tree-like arrangement, the third respective set of data, and the set of parameters; and
determining a second class-based present value of the second application class based on the tree-like arrangement and the third present value, wherein the one or more other class-based present values of other application classes include the second class-based present value.

14. The computer-implemented method of claim 12, further comprising:
determining, for the first application, a first distribution of present values across multiple systems;
comparing the first present value to the first distribution of present values;
based on comparing the first present value to the first distribution of present values, determining, for the first application, a first potential value;
determining, for the second application, a second distribution of present values across multiple systems;
comparing the second present value to the second distribution of present values;
based on comparing the second present value to the second distribution of present values, determining, for the second application, a second potential value;
determining a class-based potential value of the first application class based on the tree-like arrangement, the first potential value, the second potential value, and the set of parameters; and
determining a potential value of the system based on the tree-like arrangement, the class-based potential value, and one or more other class-based potential values of other application classes.

15. The computer-implemented method of claim 14, wherein comparing the first present value to the first distribution of present values comprises determining a difference between (i) a set of present values in a top quartile of the first distribution of present values and (ii) the first present value, and wherein determining the first potential value comprises setting the first potential value to the difference when the difference is greater than zero or setting the first potential value to zero otherwise.

16. The computer-implemented method of claim 15, wherein determining the difference between (i) the set of present values in the top quartile of the first distribution of present values and (ii) the first present value comprises:
determining the difference to be between (i) an average of the set of present values in the top quartile of the first distribution of present values and (ii) the first present value.

17. The computer-implemented method of claim 12, wherein the persistent storage also contains digital maturity metrics representing usage of the system by users, key applications used by the users, custom applications deployed on the system, usage of the first application, usage of the second application, workflow definitions, orchestrations, and integrations, wherein the digital maturity metrics are respectively associated with weights, the computer-implemented method further comprising:
obtaining distributions of the digital maturity metrics across multiple systems;
based on the distributions and a pre-defined table, assigning points to each of the digital maturity metrics;
multiplying the points for each of the digital maturity metrics by its associated weight to determine respective scores for the digital maturity metrics; and
determining an overall digital maturity score for the system based on the respective scores.

18. The computer-implemented method of claim 17, further comprising:
based on the respective scores and the overall digital maturity score, generating a set of textual recommendations suggesting how the system can improve its digital maturity.

19. The computer-implemented method of claim 17, wherein a reach factor of the overall digital maturity score is based on the usage of the system by users, the key applications used by the users, and the custom applications deployed on the system, wherein a workloads factor of the overall digital maturity score is based on the usage of the first application and the usage of the second application, wherein an automation factor of the overall digital maturity score is based on the workflow definitions, orchestrations, integrations, and the custom applications deployed on the system, and wherein digital maturity sub-scores are determined for each of the reach factor, the workloads factor, and the automation factor.

20. An article of manufacture including a non-transitory computer-readable medium, having stored thereon program instructions that, upon execution by a computing system, cause the computing system to perform operations comprising:
obtaining, by a telemetry application, a first respective set of data generated by a first application of a plurality of applications executable on the computing system, wherein persistent storage contains respective sets of data generated by each of the plurality of applications, a set of parameters of the telemetry application, and a tree-like arrangement of calculations that estimates a present value of the computing system based on the respective sets of data and the set of parameters, and wherein the applications respectively belong to application classes;
obtaining, by the telemetry application, a second respective set of data generated by a second application of the plurality of applications, wherein the first application and the second application both belong to a first application class;
determining, by the telemetry application, a first present value for the first application based on the tree-like arrangement, the first respective set of data, and the set of parameters of the telemetry application;
determining, by the telemetry application, a second present value for the second application based on the tree-like arrangement, the second respective set of data, and the set of parameters of the telemetry application;
determining, by the telemetry application, a first class-based present value of the first application class based on the tree-like arrangement, the first present value, and the second present value; and
determining, by the telemetry application, the present value of the computing system based on the tree-like arrangement, the first class-based present value, and one or more other class-based present values of other application classes.
